(19) United States
(12) Patent Application Publication
(10) Pub. No.: US 2009/0018848 A1
(43) Pub. Date: Jan. 15, 2009

(54) Method and apparatus for sending a notification to contacts of a user

(76) Inventor: Travis Vanstaaveren, Portland, OR (US)

Correspondence Address: Robert J. Ireland, PO Box 273, Banks, OR, 97106, US

(21) Appl. No.: 11/825,836

(22) Filed: Jul. 10, 2007

(51) Int. Cl. G06Q 99/00; G06F 17/30; G06F 17/40

(52) U.S. Cl. 705/1

(57) ABSTRACT

In some embodiments, a computer automatically sends notifications to contacts of a traveler, if the traveler does not indicate his return from a trip on time. The traveler arranges for a notification by logging in to a website and entering trip information regarding a trip to be taken by the traveler. The entered trip information includes the traveler's destination, a return date and time, and at least one electronic communication address for contacting a contact. If the traveler indicates his return by the return date and time, the traveler may log in to the website and cancel the notification. However, if after the return date and time, no indication is received that the user has returned from the destination, a computer automatically sends a notification to the electronic communication address, the notification indicating that the user has not returned from the destination by the return date and time.

### FIELD

The present invention relates to a method and apparatus for providing a notification to contacts of a user. More specifically, certain embodiments relate to providing a notification to user contacts that user may not have returned from a trip by the time user expected.

### BACKGROUND

Travelers sometimes tell family or friends that they are taking a trip, especially if the trip involves hazards such as mountain climbing or extreme camping. A particular traveler may tell the family and friends where he is going and when he is returning so that the family and friends will know where to begin searching if the traveler fails to return by the appointed time. This system works if friends and family check to ensure that the traveler returned at or before the appointed time, and if not, contact the proper authorities with the traveler's destination and planned itinerary.

Potential difficulties arise if the traveler is too busy to tell family or friends when and where he is going, if the family and friends forget the details of what the traveler told them, or if the family and friends fail to remember to check whether the traveler has returned by the appointed time. The family and friends system further requires the traveler to promptly contact each of the family and friends upon his safe return to prevent false concerns for the traveler and needless mobilization of search parties.

An opportunity exists to provide services for travelers to assist them in providing notice to family and friends when the traveler has not returned by the appointed time and may be lost or injured. In designing such services, one possible design consideration is convenience—the amount of work the traveler has to perform to arrange for the notices to family and friends.

Another possible design consideration for such services is the reliability of the service—the extent to which the service requires human memory to remember the travel details and respond appropriately if the need arises.

A final design consideration for such services is the confidentiality of the service—the extent to which the service keeps the trip and destination details secret until a notification need arises.

### DESCRIPTION OF THE DRAWINGS

FIG. 1 is a flow chart illustrating a method for sending a notification, consistent with some embodiments.

FIG. 2 is a flow chart illustrating a method for sending a notification, consistent with some embodiments, illustrating use of a website to send a notification.

FIG. 3 is 12 is a block diagram of an exemplary system that may be used to practice some embodiments.

### DETAILED DESCRIPTION

In described embodiments, a computer or other programmable device provides a user with a safety net and peace of mind, when the user takes a trip. That is, the computer or device provides a means to automatically notify emergency contacts if the user does not return from a trip by a return date and time.

In some embodiments, the user accesses a computer via a website to provide the computer with information about the trip. In some embodiments, this trip information includes a destination, a return date and time and an electronic communication address. The computer automatically sends a notification to the electronic address if no indication is received that the user returned from the destination by the return date and time.

As employed in this description, the term “computer” includes its ordinary meaning and includes a wide variety of programmable devices. Depending on the context, a “computer” may include a personal desktop computer, a server, a laptop computer, a handheld personal computing device, or a programmable cellular telephone. For example, a user may access a website using a cellular telephone. Then, via the website, the user logs in with and communicates trip information to a server.

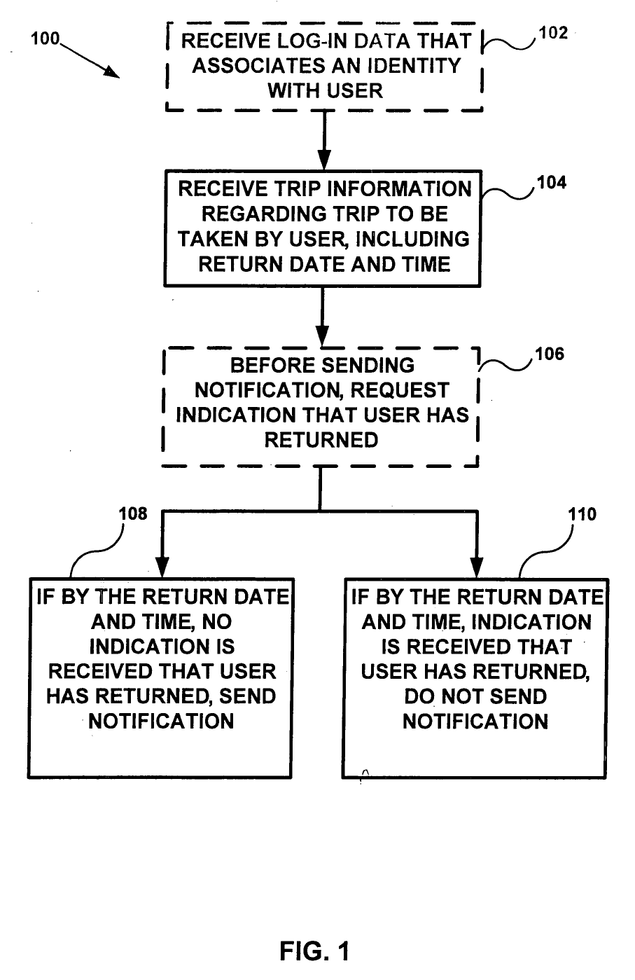

Referencing FIG. 1, in accordance with some embodiments, a method 100 for sending a notification optionally includes, before receiving trip information from a user, receiving log-in data that associates an identity with a user (Process Block 102).

In some embodiments, the user begins by logging in and submitting log-in data. In one embodiment, the log-in data associates a personal identity with the user. In one embodiment, the personal identity includes the user's name and a password.

In some embodiments, method 100 is performed at a user's personal desktop computer—which is accessed only by the user or persons having the permission of the user. In that case, a log-in procedure may not be used.

In other embodiments, method 100 is performed at a server and the user remotely accesses the server via a client computer that communicates with the server via a network. In one embodiment, the user accesses a webpage presented by the client computer and inputs data at the client computer. The client computer sends the input data to the server via the network. The server may be accessible to other users at other client computers. In these other embodiments, it may be prudent to use a log-in procedure that associates the user with a personal identity. In one embodiment, the user is authenticated by requiring the user to enter a valid password.

Further referencing FIG. 1, method 100 includes receiving, from a user, trip information regarding a trip to be taken by the user, including a return date and time when the user is to return (Process Block 104). In some embodiments, the trip information is received at a server via a network from a client computer, the user accessing the server via and inputting the trip information at the client computer—similarly to the above discussion. In one embodiment, the client computer presents a webpage that requests the trip information from the user. The user then enters the trip information in response to the request. As discussed above, the “client computer” may be one of a variety of computing devices—such as, for example, a cellular telephone or a laptop computer.

In other embodiments, the trip information is received at a computer via an input device, such as a keyboard that is communicably coupled with the computer. For example, a notification program or module that implements an embodiment of method 100 is loaded on a user's personal desktop computer. The user enters the trip information directly on the user's own personal desktop computer via the input device.

In some embodiments, the received trip information includes at least one destination associated with the trip, a return date and time when the user is to return from the destination, and at least one electronic communication address for a contact—such as a family member or other emergency contact.

In one embodiment, the trip information includes only one destination. The return date and time therefore indicates when the user is to return from the one destination. In one embodiment, the trip information includes a plurality of destinations and the return date and time indicates when the user is to return from the last destination to be visited. In a further embodiment, the trip information includes an itinerary that identifies a plurality of destinations and the respective dates and times during which the user is to visit each destination and return from. Again, the return date and time indicates when the user is to return from each or the last destination to be visited, depending on the direction of the user.

The electronic communication address is a means for automatically contacting a user's contacts electronically. The electronic communication address may be, for example, an email address or an instant messaging address. In one embodiment, the electronic communication address is a telephone number, to which a computer can send an automated voice message. In one embodiment, the electronic communication address is a cellular telephone number, to which a computer can send an automatically-generated text message.

In other embodiments, the trip information may include other information, such as, for example, the names and addresses of persons the user will be visiting at a particular destination. In one embodiment, the trip information also includes the names, addresses and other contact information for persons who will be traveling with the user.

In one embodiment, the trip information may include a message from the user. This could, for example, be a text message entered by the user. The text message could be sent as part of an email or an instant message.

In some embodiments, once the user has provided the trip information, a notification is scheduled. As discussed below, if the user does not indicate his return from the destination before the return date and time, a notification is sent to the electronic communication address indicating that the user has not indicated his returned from the destination. However, if the user indicates his return before the notification is sent, the user may cancel the notification, also as discussed below.

Further referencing FIG. 1, method 100 optionally includes, before sending a notification, requesting from the user or some other predetermined source to provide an indication that the user has returned from the destination (Process Block 106). If the indication is received, the notification is not sent. In one embodiment, this request is made at least one hour before the return date and time. In one embodiment, the request is made after the return date and time, but before a notification has been sent.

In different embodiments, the request is made in different ways. In one embodiment, the request is output as a message displayed on a computer monitor. In one embodiment, the request is an email message sent to the user's email address.

In different embodiments, the user provides different types of indications that the user has returned from the destination. In one embodiment, the indication that the user has returned from the destination is a user request to cancel the notification. That is, the cancellation serves as the indication that the user has returned from the destination. In another embodiment, the user enters a statement, or perhaps checks a box, indicating that the user has returned from destination.

In different embodiments, the user enters the indication in different ways. In some embodiments, the user provides the indication by logging in to a website managed by a server and entering the indication. In other embodiments, in which the method is performed on a user's personal desktop computer, the user enters the indication directly into an input device coupled to the computer.

After the return date and time, if no indication is received that the user has returned from the destination, a notification is sent to the electronic communication address or addresses indicating that the user has not returned from the destination by the return date and time (Process Block 108).

In different embodiments, the timing of the notification varies. In one embodiment, the notification is not sent until 24 hours after the return date and time. Thus, the user may be 24 hours late returning and still arrive in time to cancel the notification. In one embodiment, the notification is not sent until 24 hours after the user has been sent a reminder. Thus, the user may be late returning, receive a reminder, and still have an opportunity to cancel the notification.

As discussed above, in different embodiments, the nature of the indication varies. In one embodiment, the user logs in to a website and enters data indicating that the user has returned from the destination. The indication may be stored in memory for later recall or use in determining whether to send a notification. In another embodiment, the indication that the user has returned from the destination comprises an instruction from the user not to send the notification, and the cancellation may not be stored in memory for later use.

In one embodiment, the notification requests those receiving the notification to search for the user. In one embodiment, the notification identifies authorities able to initiate search and rescue. In one embodiment, the notification includes a message from the user (See above discussion regarding the trip information including a user message).

The notification may be sent in various ways, dependent upon the type of electronic communication address provided. In one embodiment, the electronic communication address is an email address and the notification is sent as an email message. In one embodiment, the electronic communication address is an instant messaging address and the notification is sent as an instant message. Other possibilities are apparent based on the above discussion of the types of electronic communication addresses that may be provided as part of the trip information.

If an indication that the user has returned is received, then the above notification is not sent (Process Block 110). In one embodiment, as discussed above, the indication that the user has returned from the destination is an instruction from the user not to send the notification—e.g., a cancellation of the notification. Once the cancellation is received, no further action is taken. In another embodiment, after the return date and time, a computer searches for a record of an indication that the user has returned. If such an indication (including a cancellation request) is found, a notification is not sent. In yet another embodiment, before the return date and time, a computer searches for a record of an indication that that the user has returned, if there is no indication, a notification is sent outlining the users trip and destination including the expected return time. In yet another embodiment, before, on, or after the return date and time, a computer or service sends out a notification outlining the users trip and destination, including the expected return time.

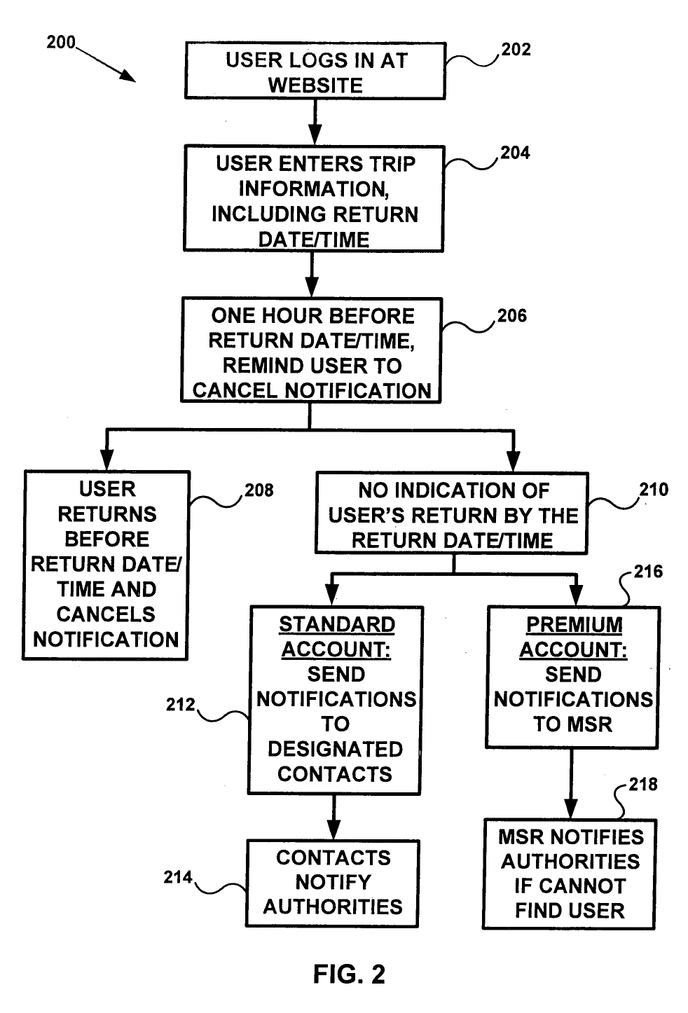

Referencing FIG. 2, in some embodiments a method 200 of sending a notification involves a user interacting with a website. In some embodiments, the method 200 includes a user logging in at the website (Process Block 202). In one embodiment, the user uses a client computer to access a website managed by a server. After logging in, the user enters, via the website, trip information that includes a return date and time (Process Block 204). In one embodiment, as discussed above relative to FIG. 1, the trip information also includes at least one destination and at least one electronic communication address of a contact to be sent a notification if the user does not return from the destination by the return date and time.

In some embodiments, at least one hour before the return date and time, the server reminds the user to log into the website and cancel the notification (Process Block 206). In one embodiment, the reminder is sent via email.

If the user returns from the destination before the return date and time, the user can log in to the website and cancel the notification (Process Block 208). If no indication is received by the destination return date and time, (Process Block 210), then one or more notifications may be sent.

In some embodiments, the user desires the trip and destination details to remain confidential, and the notification could only be sent to search and rescue professionals, thus avoiding undue stress and fear on family or friends.

In some embodiments, a business model affects what type of notification is sent. In one embodiment, a website manager provides a user with either a standard account or a premium account. For example, a premium account may be provided to a user who pays extra, who is affiliated with an organization, or who fulfills other criteria.

In some embodiments in which the user has a standard account, a notification is sent to the electronic communication addresses of contacts designated by the user (Process Block 212). These contacts may then search for the user. They may also notify the authorities that the user is late returning from the destination (Process Block 214).

In other embodiments in which the user has a premium account, a notification is sent to MSR (Process Block 216). MSR may attempt to contact or locate the user. MSR may try to communicate with persons designated by the user as contacts. If MSR does not locate the user, it notifies the authorities so that they can initiate a search and rescue operation (Process Block 218).

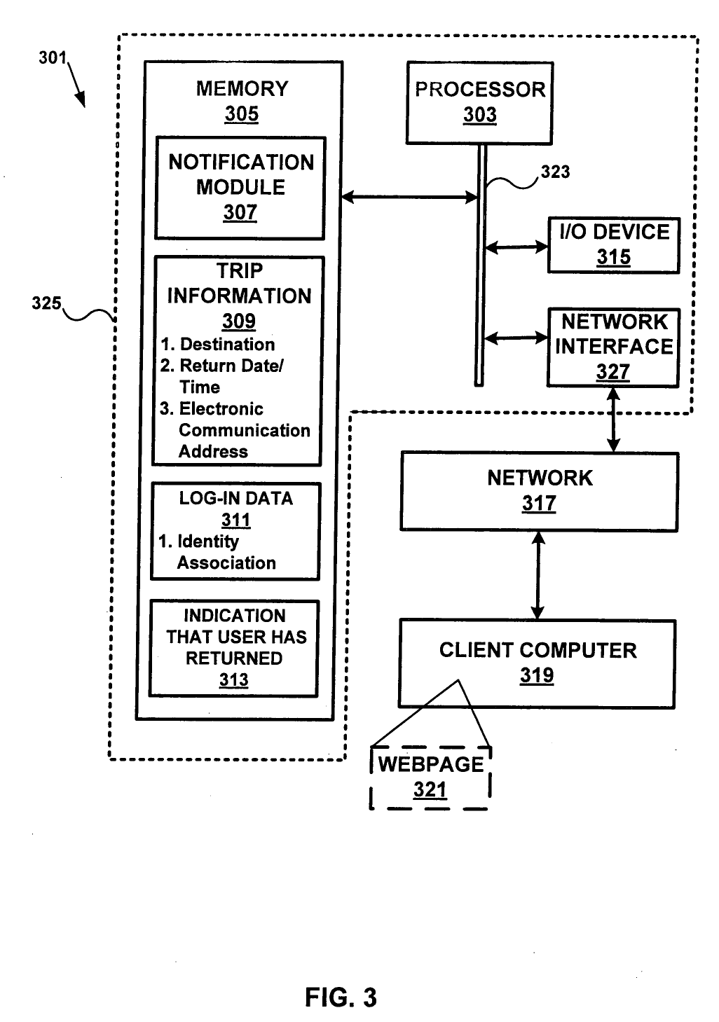

Referencing FIG. 3, according to some embodiments, a system 301 includes a server computer 325 that includes a processor 303 that is communicably coupled to a memory 305 and an input device 315 (such as a keyboard) via bus 323. The memory 305 stores a notification module 307 to instruct the processor.

In some embodiments memory 305 includes a volatile memory, such as random-access memory (RAM). In some embodiments, memory 305 includes nonvolatile memory, such as read-only memory (ROM). In some embodiments, memory 305 may include a portable memory, such as a CD ROM or a floppy disk.

In some embodiments, memory 305 comprises a computer-readable medium that stores notification module 307 as computer-executable instructions that are executed by processor 303 and cause an apparatus or machine, such as computer 325, to perform one or more methods, as described above relative to FIGS. 1 and 2.

In some embodiments, processor 303 is in communication with a client computer 319 displaying a webpage 321. As shown in FIG. 3, in one embodiment this communication is via a route that includes bus 323, network interface 327, network 317 and client computer 319.

In some embodiments, notification module 307 instructs processor 303, prior to receiving trip information, to receive log-in data 311 that associates a user with an identity. In one embodiment, the user logs in via input device 315 and log-in data 311 is received from the input device 315, via bus 323, and stored in memory 305. In some embodiments the association is with a personal identity.

In one embodiment, the user logs in via the webpage 321 displayed on client computer 319. The log-in data 311 is received via network 317 from client computer 319 and ultimately stored in memory 305.

After log in data 311 is received, the notification module instructs the processor to receive trip information 309 regarding a trip to be taken by the user. In one embodiment, the user enters the trip information 309 at the client computer 319 and the trip information is received from the client computer 319 via the network 317 and stored in memory 305. In one embodiment, the trip information 309 is requested by the webpage 321 displayed at the client computer 319 and the user enters the trip information 319 in response to the request.

In one embodiment, the user enters the trip information 309 at the input device 315 and the trip information is received via the input device 315 and stored in memory 309 as data.

In some embodiments, as discussed above relative to FIGS. 1 and 2, the received trip information 309 indicates at least one destination, a return date and time when the user is to return from the destination, and at least one electronic communication address for a contact person.

In some embodiments, if the user returns from the destination before the return date and time, the user accesses system 301 via, for example, input device 315 or client computer 319, and provides an indication 313 that the user has returned from the destination. In one embodiment, the indication is stored in memory 305. In other embodiments, an indication 313 is not stored in memory 305. In one embodiment, if the user returns from the destination before the return date and time and cancels the notification, the indication 313 (i.e., the cancellation) is not stored in memory 305.

In some embodiments, before a notification is sent, the notification module 307 instructs the processor to request from the user an indication that the user has returned from the destination. As discussed above, if an indication is received, the notification is not sent.

After the return date and time, if no indication is received that the user has returned from the destination, the notification module 307 instructs the processor 303 to send a notification to the electronic address or addresses indicating that the user has not returned from the destination by the return date and time. Said notification may include directions and other details that would be helpful to search and rescue professionals.

If the electronic communication address is an email address, the notification module 307 instructs the processor 303 to send the notification as an email message. In other embodiments, the electronic communication address is an instant message address and the notification module 307 instructs the processor 303 to send the notification as an instant message.

At time reference is made to “one embodiment” or to “some embodiments.” All the embodiments referred to as “one embodiment” or “some embodiments” are not necessarily the same embodiment or embodiments.

The foregoing embodiments and advantages are merely exemplary and are not to be construed as limiting the present invention. Those skilled in the art can appreciate from the foregoing description that the techniques of the embodiments of the invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

I claim:

1. A computer-implemented method for sending a notification, comprising:
receiving trip information regarding a trip to be taken by the user, said trip information indicating:
at least one destination associated with said trip;
a return date and time when the user is to return from said destination; and
at least one electronic communication address; and
if, after the return date and time, no indication is received that the user has returned from said destination, sending a notification to the at least one electronic communication address, the notification signifying that no indication has been received that the user has returned from said destination by the return date and time.

2. The method of claim 1, further comprising:
before sending the notification, requesting indication that the user has returned from said destination; and
if the indication is received, not sending the notification.

3. The method of claim 1, further comprising:
sending a message to at least one electronic communication address before sending notification.

4. The method of claim 1, wherein the indication that the user has returned from the destination comprises an instruction from the user not to send the notification.

5. The method of claim 1, wherein the notification identifies authorities able to initiate search and rescue operations.

6. The method of claim 1, further comprising:
prior to receiving said trip information from the user, receiving log-in data that associates a personal identity with the user.

7. The method of claim 1, wherein the electronic communication address is an email address and the notification is sent as an email message.

8. The method of claim 1, wherein the notification further includes a message from the user.

9. A computer-readable storage medium comprising a plurality of computer-executable instructions that, in response to being executed, result in a machine performing the following method:
receiving trip information regarding a trip to be taken by the user, said trip information indicating:
at least one destination associated with said trip;
a return date and time when the user is to return from said destination; and
at least one electronic communication address; and
if, after the return date and time, no indication is received that the user has returned from said destination, sending a notification to the at least one electronic communication address, the notification signifying that no indication has been received that the user has returned from said destination by the return date and time.

10. The method of claim 9, further comprising:
before sending the notification, requesting the indication that the user has returned from said destination; and
if the indication is received, not sending the notification.

11. The method of claim 9, wherein said trip information is received via a network from a client computer and wherein the user enters said trip information at the client computer.

12. The method of claim 11, further comprising:
presenting a webpage at the client computer that requests said trip information from the user;
wherein the user enters said trip information in response to the request.

13. The method of claim 9, wherein said trip information is received from an input device communicably coupled to the computer, the user entering said trip information at the input device.

14. The method of claim 9, wherein the electronic communication address is an instant messaging address and the notification is sent as an instant message.

15. An apparatus comprising:
a processor;
a memory communicably coupled to the processor; and
a notification module stored in the memory to instruct the processor:
to receive trip information regarding a trip to be taken by the user, said trip information to indicate:
at least one destination associated with said trip;
a return date and time when the user is to return from said destination; and
at least one electronic communication address; and
if, after the return date and time, no indication is received that the user has returned from said destination, sending a notification to the at least one electronic communication address, the notification to signify that no indication has been received that the user has returned from said destination by the return date and time.

16. The apparatus of claim 15, the notification module further to instruct the processor:
before sending the notification, to request the indication that the user has returned from said destination; and
if the indication is received, to not send the notification.

17. The apparatus of claim 15, the notification module further to instruct the processor:
prior to receiving said trip information from the user, to receive log-in data that associates a personal identity with the user.

18. The apparatus of claim 15, wherein said trip information to be received via a network from a client computer and wherein the user to enter said trip information at the client computer.

19. The apparatus of claim 15, wherein the electronic communication address is to be an email address and the notification is to be sent as an email message.

20. The apparatus of claim 15, wherein the electronic communication address is to be a messaging contact and the notification is to be sent as a message to said messaging contact.
